(19) United States
(12) Patent Application Publication
(10) Pub. No.: US 2014/0230324 A1
(43) Pub. Date: Aug. 21, 2014

(54) Spun Material Based Mass Plant Growing System Labeling Apparatus

(71) Applicant: Hooshmand Harooni, Los Angeles, CA (US)

(72) Inventor: Hooshmand Harooni, Los Angeles, CA (US)

(21) Appl. No.: 13/769,807

(22) Filed: Feb. 18, 2013

(51) Int. Cl. A01G 9/00

(52) U.S. Cl. CPC A01G 9/006
USPC 47/65.8

(57) ABSTRACT

This invention describes a multi-purpose, optionally detachable labeling system that, when used in conjunction with substrate, spun material, or medium based mass plant growing systems with highly absorbent materials such as mineral wool or rockwool, provides for a mechanism to accurately label a growing plant sapling and to be able to associate that label with the specific plant as the plant grows.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

A substrate or other absorbent medium based plant growing system is a system. where the roots of the plant being grown are physically supported by a natural or man-made medium that is encased in a plastic or paper casing. This medium can be made from a variety of materials, one very common material is rockwool, a man-made mineral fiber, generally made. of a mixture of basalt. and chalk that is heated and then spun. into tightly wound porous fibers much like the manner in which cotton candy is spun from a sugar base. There are several other spun materials that are also used in addition to rockwool, including spun polyester, highly compressed peat moss, spun glass, spun peat moss, and spun recycled paper fibers. These fibers are then cut into blocks or small cylinders, with a small pre-dug hole in one side into which the stem end (the point at which the plant cutting is cut from the parent plant) of a small plant sapling can be placed. This type of medium is effective in the nurturing and growth of plants as the spun substrate material is highly water and nutrient absorbent. Also, unlike more fluid based growth environments, the substrate provides a supportive function to the plant sapling that allows it to successfully grow its own root system and furthermore encourages it to grow as an independent plant. In addition, the casing around the substrate is enclosed on all four sides, but not the top or bottom, forcing the roots of the plant sapling to grow downwards, helping to keep adjacent plant roots from becoming intertwined with one another.

Plant saplings are often grown in a large collection of absorbent substrate blocks, often with dozens if not hundreds grown in close proximity to one another, collectively together in large plant beds or in a tray arrangement. Sometimes the plant beds are immersed. in water such as in a hydroponic plant growth environment. One problem that growers face in this type of mass growing environment is that each sapling must be individually labeled with the date, plant strain, and other miscellaneous notes associated with that specific plant. Many growers write on the outside of the casing, or attempt to insert tags into the substrate itself to identify specifics about the plant. The problem with all of these approaches is that they lose their specificity to the plant in question as the plant grows and outgrows its substrate casing. The “Spun Material Based Mass Plant Growing System Labeling Apparatus” that is the subject of this application solves this problem by allowing growers to use the casing itself to denote or label the specifics about the sapling being grown, then to be able to optionally easily tear off a perforation integrated into the casing or to simply slide the casing off of the substrate block, and to quickly and easily in one swift operation slide the casing up and, if perforated, reattach to the trunk of the growing plant. In so doing the label originally marked on the casing itself transforms itself into a label that is attached. to the growing plant without need to re-inscribe the specifics of the plant on another label.

The mechanism proposed by the “Spun Material Based Mass Plant Growing System Labeling Apparatus” invention is applicable to both cube shaped and cylinder shape substrate blocks. Initially the “Spun Material Based Mass Plant Growing System Labeling Apparatus” is wrapped around the substrate block and attached by a small glue strip on one end of the casing. In one variation, as the plant grows larger, the integrated perforation can be torn to separate the casing from the substrate block, and to then reattach the casino to the trunk of the plant by threading one end of the casing through a slot in the other end of the casing. Notches built into the sides of the casing are used to anchor and adjust to the diameter of the plant trunk that the label is being attached to. Because there are multiple notches on the casing, as the plant grows and the trunk grows larger in diameter the casing label can be adjusted to another notch to accommodate the plant growth. In another variation, the casing can simply be slid off of the substrate material, and moved upwards to be around the trunk of the plant trunk as it crows, providing the same benefit to never disassociate the casino label from the specific plant to which it belongs.

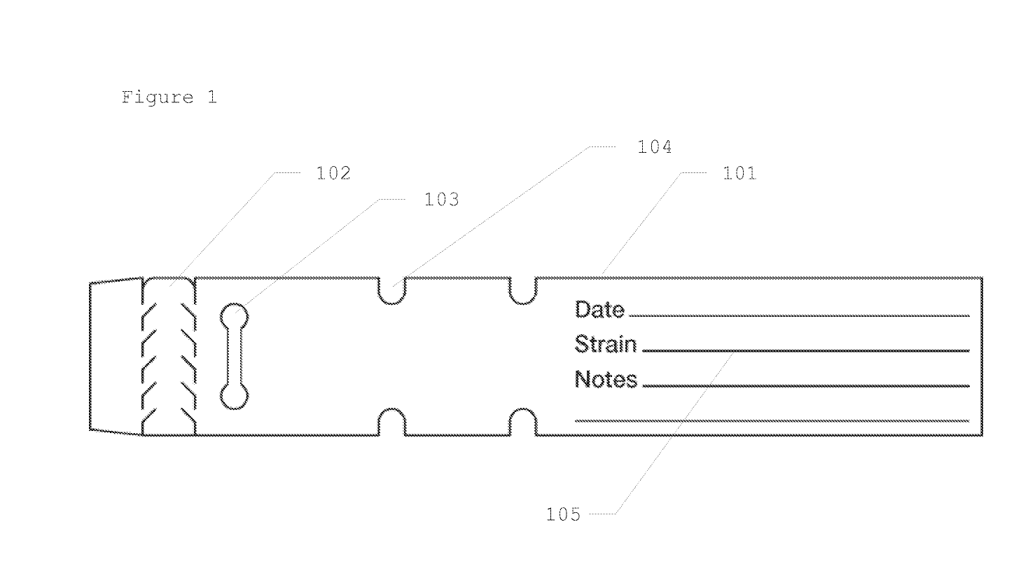

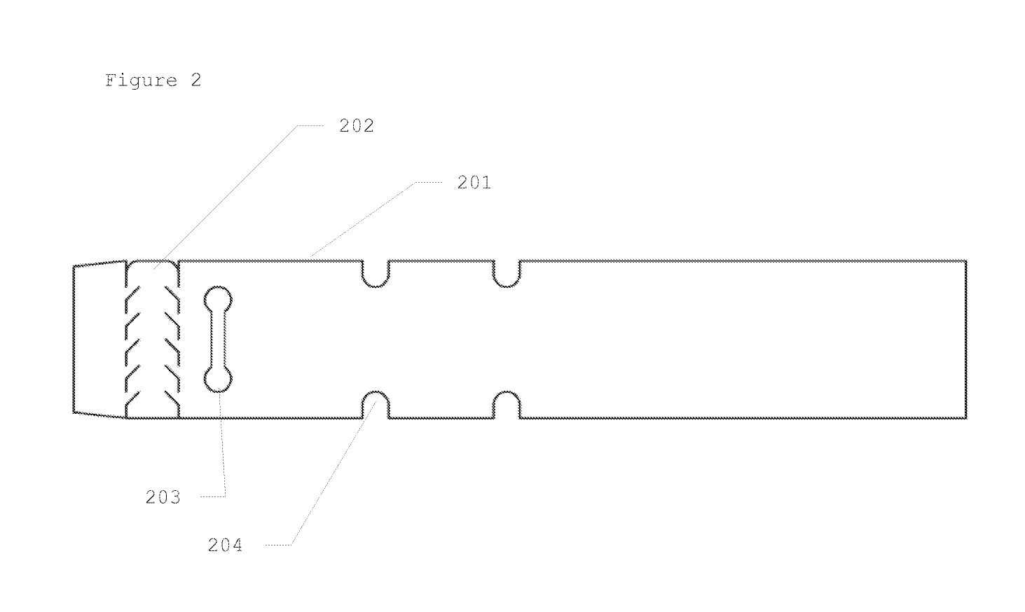

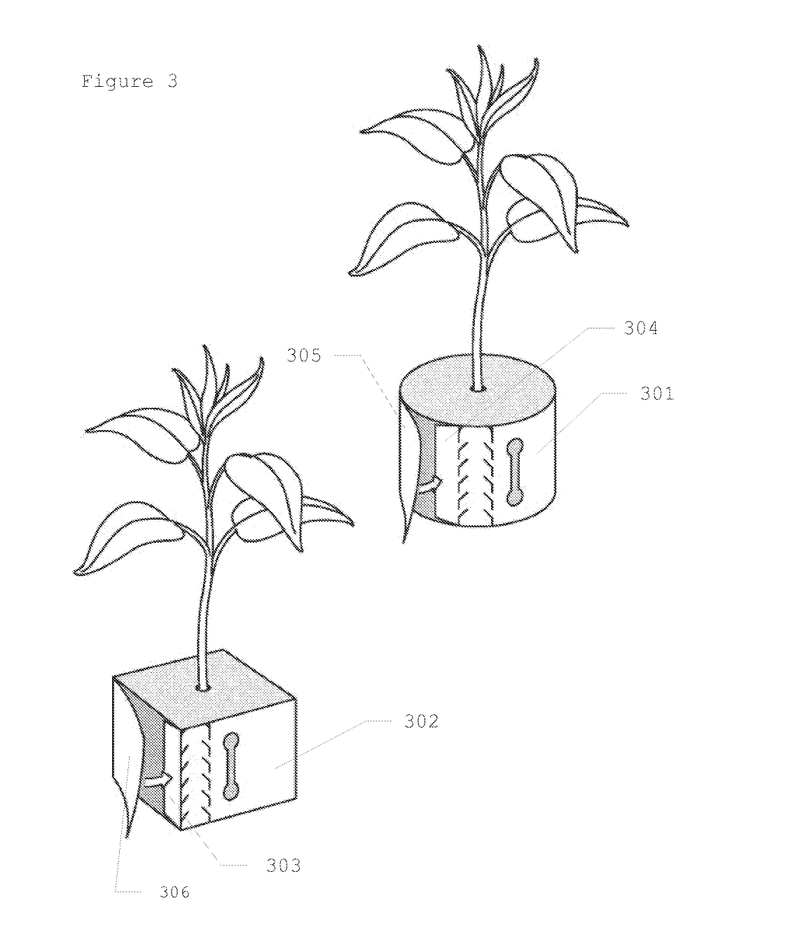

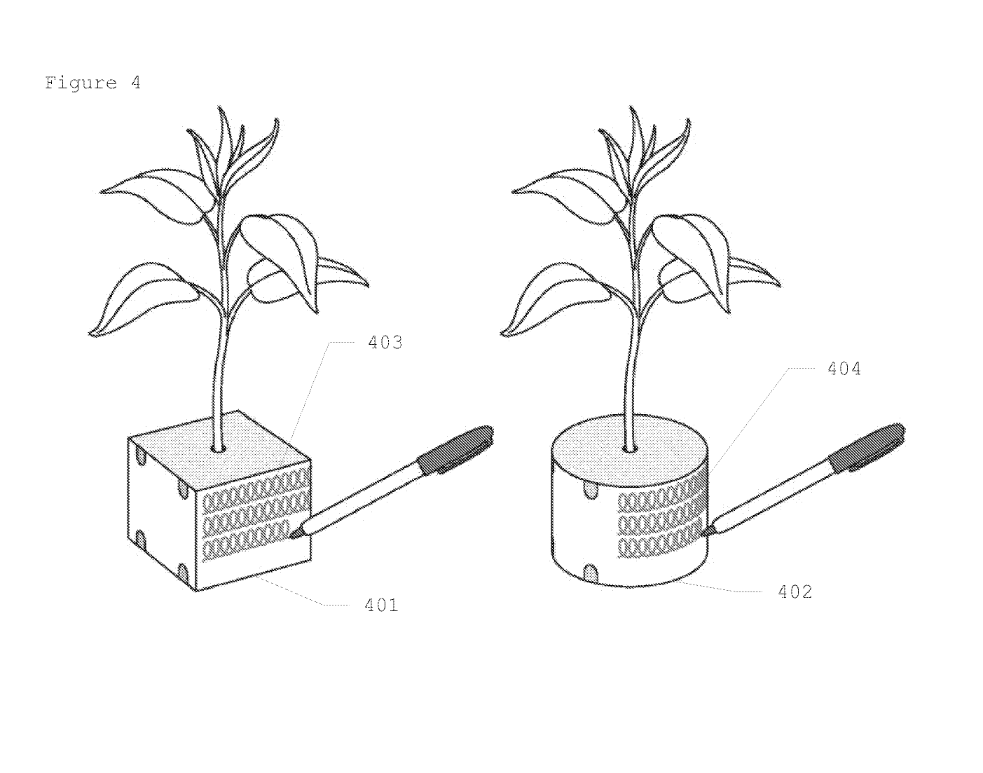

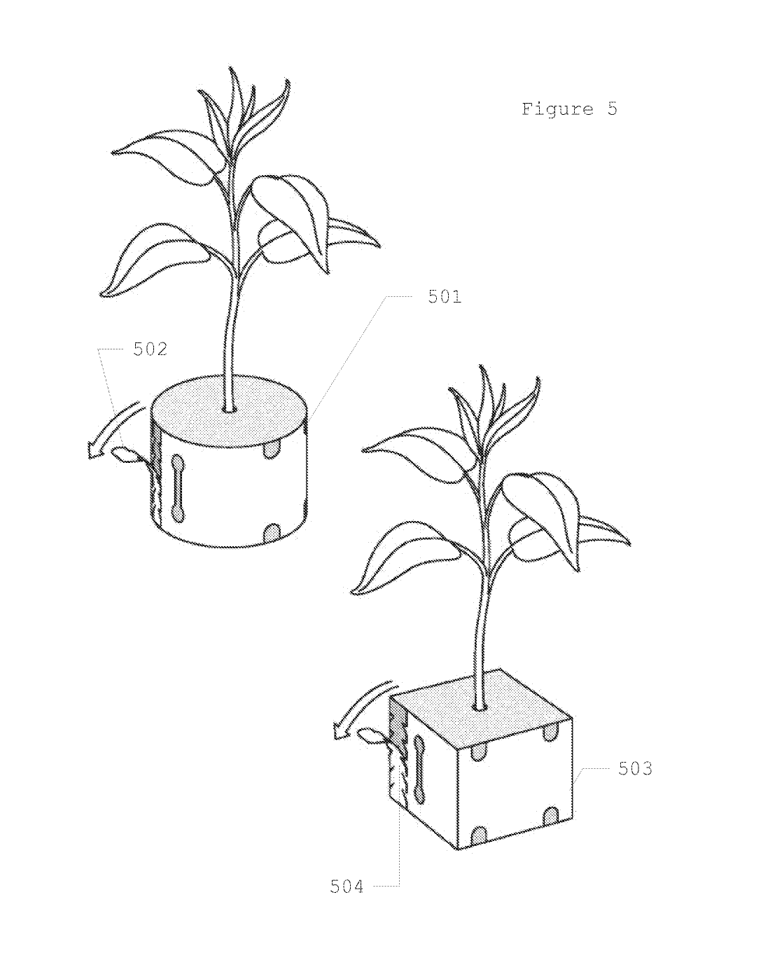

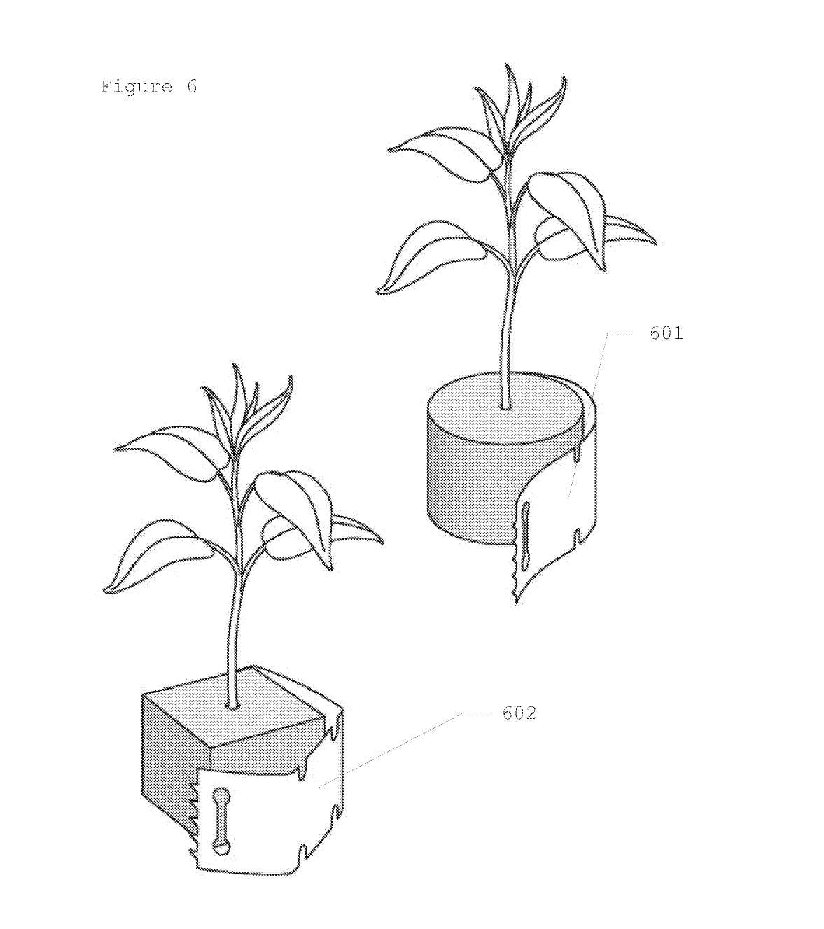

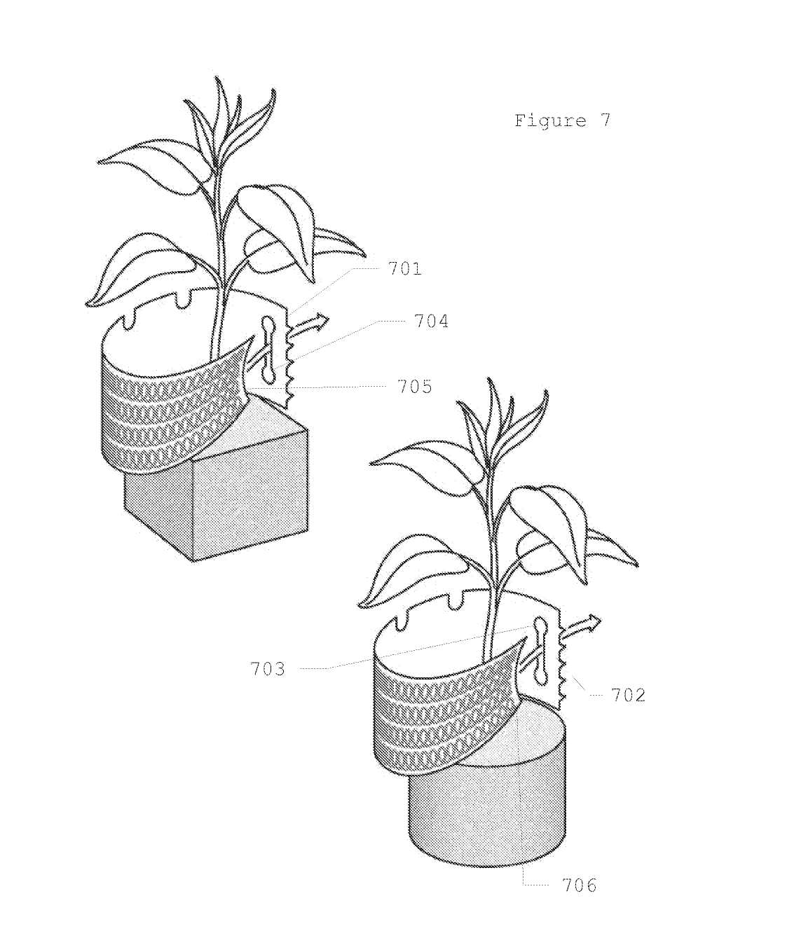

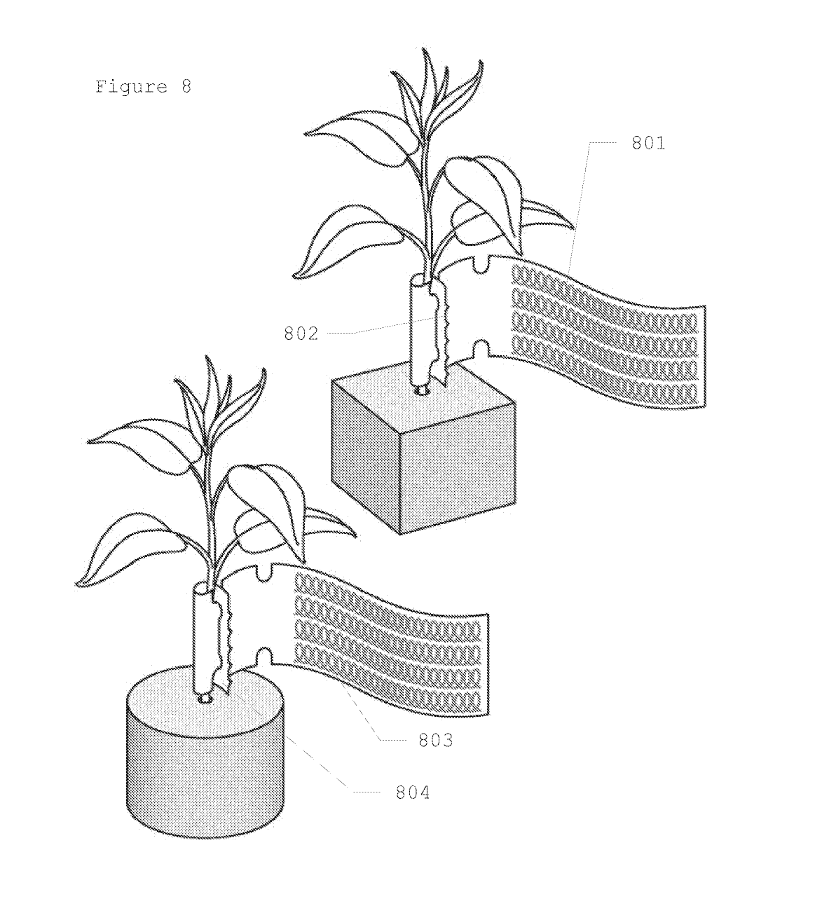

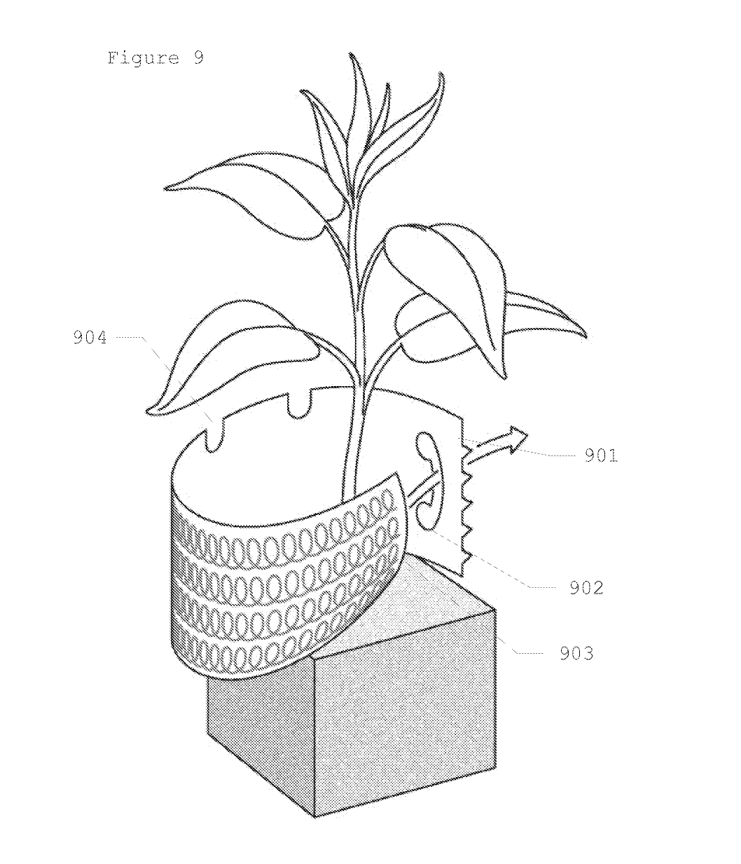

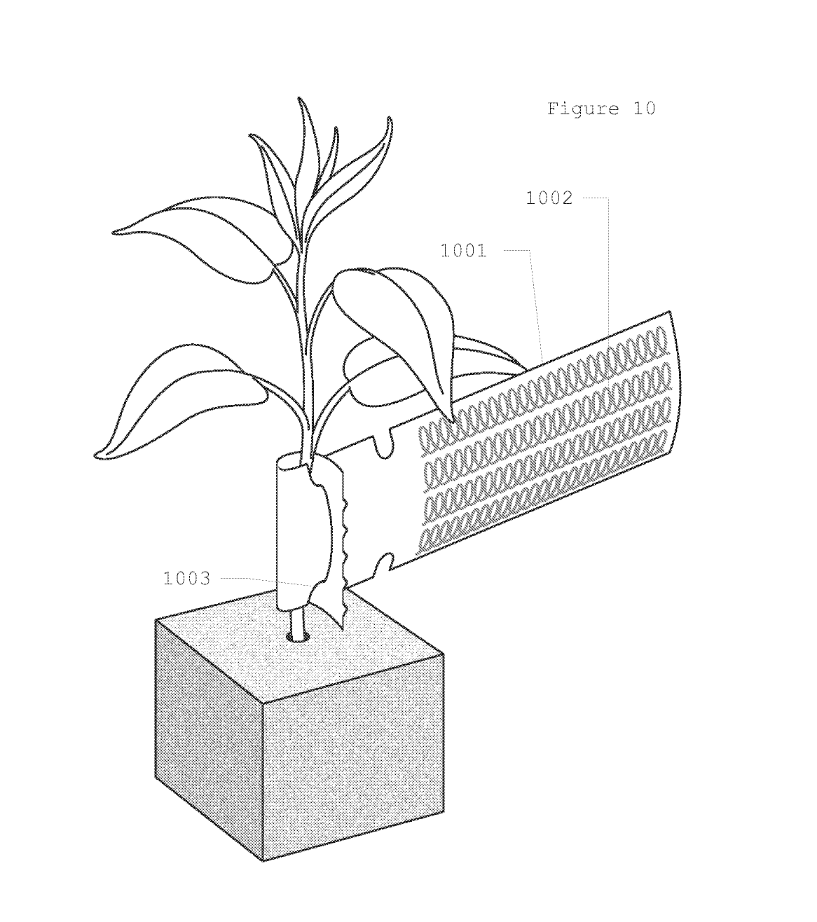

### BRIEF DESCRIPTION OF THE DRAWINGS

<FIG. 1> Front view of the “Spun Material Based Mass Plant Growing System Labeling Apparatus” shown prior to attachment around the substrate hydroponic growing block. Front view shows the label area built into the apparatus.

<FIG. 2> Back view of the “Spun Material Based Mass Plant Growing System Labeling Apparatus”.

<FIG. 3> Two applications of the “Spun Material. Based Mass Plant Growing System Labeling Apparatus”, one on a square substrate block and the other on a cylindrical substrate block.

<FIG. 4> Illustrations of labeling the exterior surface of the “Spun Material Based Mass Plant Growing System Labeling Apparatus” with a marker.

<FIG. 5> Illustration of beginning to tear the perforation off of the “Spun Material Based Mass Plant Growing System Labeling Apparatus” in preparation for attachment to the trunk of the growing plant.

<FIG. 6> Illustrations showing the perforation strip of the “Spun Material Based Mass Plant Growing System Labeling Apparatus” completely removed in preparation for removal from the substrate block.

<FIG. 7> Illustrations showing the threading of one end of the “Spun Material Based Mass Plant Growing System Labeling Apparatus” through a slot for attachment to the crowing plant.

<FIG. 8> Illustrations showing the “Spun Material Based Mass Plant Growing System Labeling Apparatus” completely threaded through the built-in slot and attached to the growing plant.

<FIG. 9> Detailed illustration of the threading mechanism of the “Spun Material Based Mass Plant Growing System Labeling Apparatus” through the built in slot and notches.

<FIG. 10> Detailed illustration of the “Spun Material Based Mass Plant Growing System Labeling Apparatus” secured to the plant trunk by notching.

### DETAILED DESCRIPTION OF THE INVENTION

<FIG. 1> shows a frontal view of the “Spun Material Based Mass Plant Growing System Labeling Apparatus”, prior to being attached to any substrate block. 101 shows the open, unattached “Spun Material Based Mass Plant. Growing System Labeling Apparatus”. 102 shows the perforation strip that can be used later to remove the apparatus from the substrate block, and then reattached to the plant trunk by ensuring the notches at 104 line up with the ends of the slot 103. In 105 can be seen the label area that is used to denote the specifics about the plant strain, date, and additional relevant statistics as required using a marker device.

<FIG. 2> shows a back. view of the “Spun Material Based Mass Plant Growing System Labeling Apparatus”, 201. 202 again shows the back of the perforation, with the notches at. 204 lining up inside of the slot 203 once the label is attached to the trunk of she growing plant.

<FIG. 3> shows the “Spun Material Based Mass Plant Growing System Labeling Apparatus” being attached so a substrate block. 301 shows the label apparatus being attached to a cylindrical substrate block with the opposing edge 305 being pressed against an integrated glue strip placed at 304 to attach the label to the substrate block. Similarly, 302 shows the label apparatus being attached to a cubed substrate block. 302 shows the label apparatus attached to a cubed substrate block with the opposing edge 306 being pressed against an integrated glue strip placed at 303 to attach the label to the substrate block.

<FIG. 4> depicts the “Spun Material Based. Mass Plant Growing System Labeling Apparatus” attached to the substrate block. 401 shows the label apparatus attached to a cubed. substrate block, with the label being marked with a marking device on the exterior of the label at 403. Similarly, 402 shows the label apparatus attached to a cylindrical substrate block, with the label being marked with a marking device on the exterior of the label at 404.

<FIG. 5> depicts the “Spun Material Based Mass Plant Growing System Labeling Apparatus” being prepared to be removed from the substrate block in order to be later attached to the trunk of the plant being grown. 501 depicts the label apparatus attached to a cylindrical substrate block with the perforation strip being torn in 502 in the direction shown. Similarly, 503 depicts the label apparatus attached to a cubed substrate block with the perforation strip being torn in 504 in the direction shown.

<FIG. 6> shows two examples of the “Spun Material Based Mass Plant Growing System Labeling Apparatus” being removed from the substrate block. 601 shows the perforation completely removed from a label apparatus being removed from a cylindrical substrate block, and 602 shows the perforation completely removed from a label apparatus being removed from a cubed substrate block.

<FIG. 7> depicts the method used to attach the “Spun Material Based Mass Plant Growing System Labeling Apparatus” to the trunk of a growing plant. 701 depicts one end of the label apparatus fully removed from a cubed substrate block. The other end 705 is threaded through the slot at 704 in order to attach the label apparatus to the trunk of the plant. Similarly, 702 depicts one end of the label apparatus fully removed from a cylindrical substrate block. The other end 706 is threaded through the slot at 703 in order to attach the label apparatus to the trunk of the plant.

<FIG. 8> depicts the “Spun Material Based Mass Plant Growing System Labeling Apparatus” completely attached to the trunk of a growing plant. 801 depicts the label apparatus securely attached to a cubed substrate block, clearly showing the label area on the label apparatus, and with the apparatus attached to the plant securely with the notches aligned at the slots as shown in 802. Similarly, 803 depicts the label apparatus securely attached to a cylindrical substrate block, clearly showing the label area on the label apparatus, and with the apparatus attached to the plant securely with the notches aligned at the slots as shown in 804.

<FIG. 9> shows the detail around the “Spun Material Based Mass Plant Growing System Labeling Apparatus” being attached to a growing plant trunk. The perforated. end of the label apparatus is depicted at 901, with the other end 903 being threaded through the slot at 902 in the direction of the arrow in order to securely attach the label apparatus to the growing plant trunk. 904 shows the detail of the notches that will secure the label apparatus to the trunk of the plant when one end of the apparatus is pulled through the slot at 902.

Finally, <FIG. 10> depicts the “Spun Material Based Mass Plant Growing System Labeling Apparatus” completely and securely attached to the trunk of a growing plant. 1002 depicts the label area of the label apparatus 1001 securely attached with the notches aligned no the slots shown in 1003.

What is claimed is:

1. This invention (hereinafter known as “Spun Material Based Mass Plant Growing System Labeling Apparatus”) provides for a labeling system integrated into the casing for a substrate or medium based mass plant growth system utilizing absorbent materials such as mineral wool or rockwool; wherein said substrate can be from either natural or man-made materials;
wherein said casing can be initially labeled to identify the plant sapling, and to provide for a label that can be later detached and re-attached to the growing plant such that the identification label is always physically associated with the growing plant.

2. The “Spun Material Based Mass Plant Growing System Labeling Apparatus” claim 1, further providing for a casing that has an integrated perforation that can be used to tear the casing away from the natural or man-made substrate; further providing for a casing with a slot and notches which when utilized said casing can be reattached to the trunk of the growing plant sapling; wherein the labeling originally associated ted with the substrate casing is then transferred to the growing plant without physically being separated from the plant at any time and therefore maintaining the continued association.

3. The “Spun Material Based Mass Plant Growing System Labeling Apparatus” in claim 1, further providing for a casing that does not have any perforations; providing for a casing that simply slides up off of the substrate and onto the trunk of the growing plant sapling without any tearing being necessary; wherein the labeling originally associated with the substrate casing is then transferred to the growing plant without physically being separated from the plant at any time and therefore maintaining the continued association.
